(19) United States
(12) Patent Application Publication
(10) Pub. No.: US 2025/0208922 A1
(43) Pub. Date: Jun. 26, 2025

(54) DYNAMIC PRECISION MANAGEMENT IN GRAPHICS PROCESSING

(71) Applicant: Advanced Micro Devices, Inc., Santa Clara, CA (US)

(72) Inventor: Yu Ma, Shanghai (CN)

(73) Assignee: Advanced Micro Devices, Inc., Santa Clara, CA (US)

(21) Appl. No.: 18/392,392

(22) Filed: Dec. 21, 2023

(51) Int. Cl. G06F 9/50; G06T 15/00

(52) U.S. Cl. CPC G06F 9/505; G06T 15/005

(57) ABSTRACT

A technique for controlling processing precision is provided. The technique includes identifying a first set of execution instances to operate at a normal precision and a second set of execution instances to operate at a reduced precision; and operating the first set of execution instances at the normal precision and the second set of execution instances at the reduced precision.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a system for increasing execution speed, according to an example;

FIG. 5 illustrates an example of adjusting the precision for a particular execution instance; and

FIG. 6 is a flow diagram of a method for operating a device with reduced or normal precision, in accordance with an example.

### DETAILED DESCRIPTION

A technique for controlling processing precision is provided. The technique includes identifying a first set of execution instances to operate at a normal precision and a second set of execution instances to operate at a reduced precision; and operating the first set of execution instances at the normal precision and the second set of execution instances at the reduced precision.

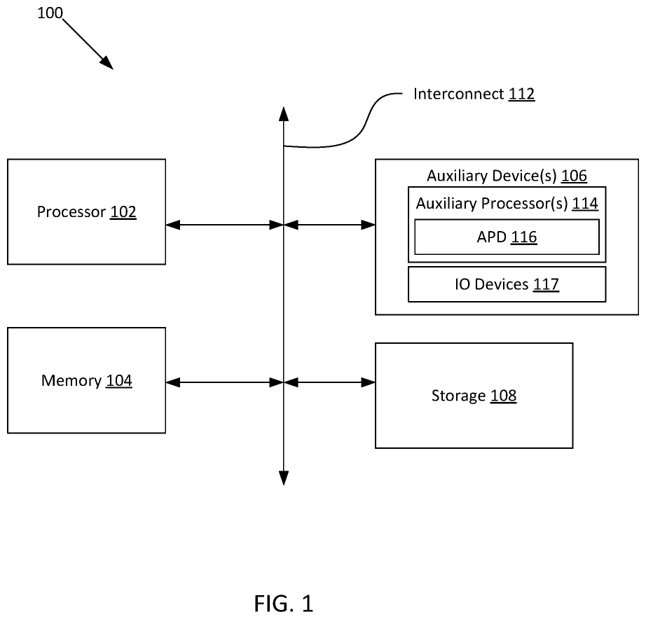

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

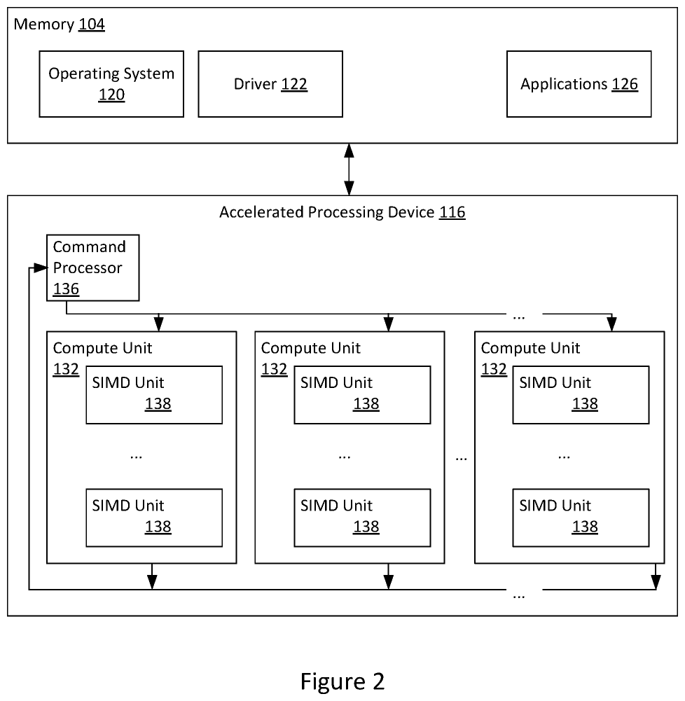

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

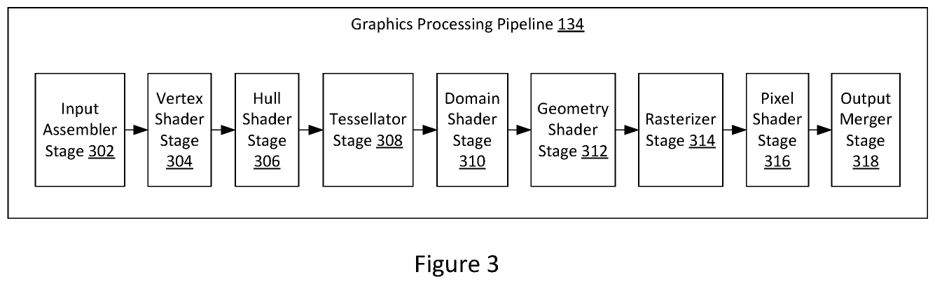

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

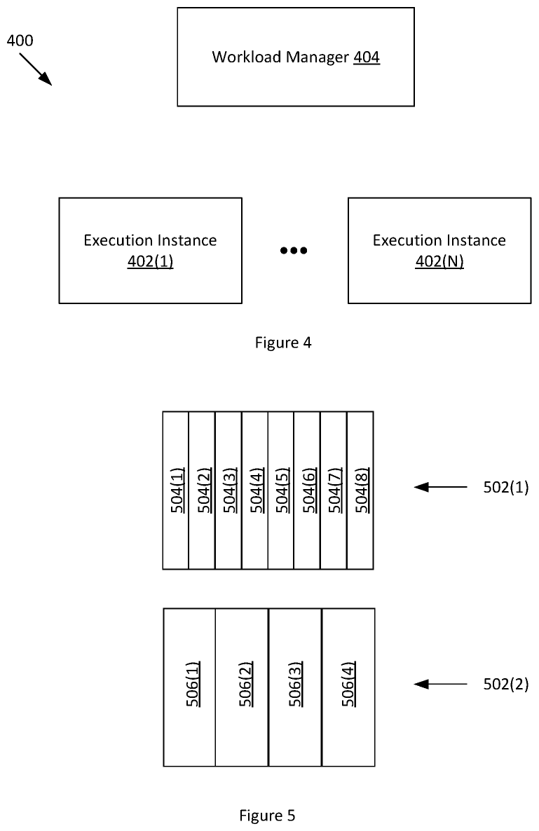

FIG. 4 illustrates a system 400 for increasing execution speed, according to an example. The APD 116 is a massively parallel computing device. This computing parallelism exists at different levels of a hierarchy, and is manifested both in the hierarchical organization of software elements and hardware elements. For instance, work can be launched as a shader program which executes multiple workgroups. Each workgroup can have multiple wavefronts and each wavefront consists of multiple work-items. The workgroups are parallel software constructs and the wavefronts are also parallel software constructs. On the hardware side, the APD 116 includes multiple compute units 132, each of which includes multiple SIMD units 138. In this instance, the parallel constructs are the compute units 132 and/or the SIMD units 138. Herein, such items of parallelism are referred to collectively as execution instances 402. More explicitly, the execution instances 402 comprise any of a software level parallelism construct (e.g., a shader program invocation such as a kernel instance, workgroup, or wavefront), or any of a hardware level parallelism construct (e.g., a compute unit 132 or an SIMD unit 138). There are memories stored within the APD 116 or in another location that store data and/or instructions for the execution instances.

At any such degree of parallelism, it is possible for one or more execution instances 402 to have a much higher workload (be “much more busy”) than the other execution instances 402. Such a situation could be disadvantageous, as it could result in a situation in which processing needs to wait on a small number of execution instances 402 to complete while other execution instances 402 sit idle, before proceeding to subsequent work. In an example, when a first rendered frame requires execution of, say, 10 execution instances 402, and 9 of those execution instances complete in half of the time of the 10^{th} execution instance 402, the entire frame is in effect “held up” or “slowed down” by the most busy execution instance 402. In another example, where 9 compute units 132 complete in half of the time of a 10th compute unit 132, the 10th compute unit “holds up” the entire workload.

For this reason, a workload manager 404 is configured to speed up the busiest execution instances 402 by reducing the precision of such instances 402 to allow more work to complete in a given amount of time. More specifically, the workload manager 404 detects execution instances 402 having a workload measure that is above a threshold and, in response to such detection, speeds up such execution instances 402 by reducing the precision with which those execution instances 402 perform calculations.

The “precision” referred to is the number of bits afforded to the operations (e.g., floating point operations) performed by the work-items executing in parallel in the SIMD units 138. More specifically, floating point calculations are performed to a certain precision, which is based on the number of bits used in the calculations. The greater the number of bits, the more precise the calculations can be performed. Calculations performed in the APD 116 are performed in a SIMD manner, in which a set of very wide functional units (e.g., adders, multipliers, etc.) perform the same operations for different work-items. By reducing the number of bits afforded to each work-item, the number of operations that can be performed in parallel on the SIMD units 138 is increased. Thus, the act of reducing the precision of operations by the workload manager 404 speeds up execution of those operations. It should be understood that the “precision” referred to is specified by the execution instances 402. In an example where the execution instances 402 are fixed function hardware, the execution instances 402 are configured to execute with a given precision. In an example where the execution instances 402 are software, the instructions of the software specify a particular precision. In any of these examples, reducing the precision means executing the execution instances 402 with a precision that is lower than that specified by the execution instances 402 (e.g., specified by the instructions or built into the hardware).

In various examples, the workload manager 404 is implemented as hardware (e.g., a circuit, such as a programmable processor, fixed-function circuitry, field programmable gate array, or any other type of circuit), software executing on a programmable processor, or a combination thereof. In some examples, the workload manager 404 is or is part of the command processor 136. In other examples, the workload manager 404 is a different part of the APD 116.

Above, it is stated that the workload manager 404 reduces the precision of calculations performed by one or more of the execution instances 402 in response to detecting that the workload of one or more of the execution instances 402 is above a threshold. In some examples, the workload manager 404 reduces the precision of the one or more execution instances 402 that have workload greater than the threshold. In such examples, the workload manager 404 does not reduce the precision of the execution instances 402 that have a workload less than the threshold. Such execution instances 402 are operated with “normal precision” or “non-reduced precision.”

In some examples, reducing the precision includes causing the work-items of the execution instance 402 to execute with a smaller number of bits than for normal precision. In an example, the reduced precision work-items execute with 16 bits and the normal precision work-items execute with 32 bits.

Above, it is stated that the workload manager 404 measures the workloads (the “workload measures”) of the execution instances 402 in order to make a determination as to whether to reduce the precision for one or more such execution instances 402. The workload manager 404 performs such measurement in any technically feasible manner. In various examples, the workload manager 404 considers one or more of the following items to determine the workload of the execution instances 402: one or more hardware performance counters, one or more software performance counters, or the occupancy of the execution instances 402. In various examples, the performance counters indicate how many workloads are assigned to each instance. In some examples, a driver or application informs the workload manager 404 of how much workload an execution instance is performing. In some examples, for depth and stencil tests, the workload measure is the amount of data processed per benchmark period (e.g., the amount of depth or stencil tests performed in a given amount of time). In general, the workload manager 404 derives a workload measure from one or more of the above items to quantify the degree to which each execution instance 402 is busy and makes a decision regarding whether to reduce the precision of an execution instance 402 based on this workload measure. For example, the number of depth or stencil tests performed in a given amount of time affects the precision with which those tests are performed. In an example, if the default precision is 32 bit floating point, then if the number of tests performed in a given unit of time is above a threshold, the precision is reduced to a 16 bit floating point number. In some examples, the application understands the complexity of a scene to be rendered and informs the workload manager 404 of a workload based on that complexity. In an example, for a scene with many polygons and/or high pixel shading workload, the application knows that the workload amount is much higher than for a scene with fewer polygons and/or a lower pixel shading workload. The application instructs the workload manager 404 accordingly.

In various examples, the threshold is set in a relative manner (e.g., based on the workload measures actually observed for the execution instances 402) or in an absolute manner (e.g., based on some fixed number that is not based on the actual workload measure observed). In some examples, the threshold is based on how clustered together the workload measures of a set of execution instances 402 are. For example, the threshold may be one standard deviation above the mean of the workload measure for a set of execution instances 402 considered together. (Such a set may be all execution instances 402 in an APD 116, all in a compute unit 132, all in a SIMD unit 132, all in a wavefront, workgroup, or kernel dispatch, or could be any other grouping of execution instances 402).

In some examples, the workload manager 404 determines which execution instances 402, if any, to reduce precision for, multiple times over time. In some examples, the workload manager 404 performs this operation periodically or according to any technically feasible schedule or rhythm. In some examples, each time the workload manager 404 performs this operation, the workload manager 404 determines whether or not to operate an execution instance 402 at a reduced precision or a normal precision for each execution instance 402 of a set of execution instances 402. In some examples, if no execution instances 402 meet the criteria for operating at a reduced precision, then the workload manager 404 does not operate any such execution instance 402 at the reduced precision (and causes those execution instances 402 to execute at the normal precision). In other examples, the workload manager 404 reduces the precision for all execution instances 402 determined to meet the criteria for operating at the reduced precision and sets the precision to a normal precision for all execution instances 402 determined to not meet the criteria for operating at the reduced precision. Note that it is possible for the operation of any given execution instance 402 to vary over time regarding whether it is operated at a reduced precision or a non-reduced precision. In other words, the workload manager 404 controls the precision of any given execution instance 402 over time based on the workload of that execution instance 402.

In some examples, the workload manager 404 adjusts the precision of the execution instances 402 for every frame, or for at least some frames in a sequence of generated video output.

As described above, the workload manager 404 adjusts the precision for the execution instances 402. FIG. 5 illustrates an example of adjusting the precision for a particular execution instance 402. Specifically, the reduced-precision configuration 502 (1) includes eight reduced-precision work-items 504 and the normal-precision configuration 502 (2) includes four normal-precision work-items 506. The calculations of the normal-precision work-items 506 require a greater number of bits than those for the reduced-precision work-items 504. Thus, given a particular quantity of computing resources, the number of normal-precision work-items 506 that can be performed in a given unit of time is less than the number of reduced-precision work-items 504 that can be performed. In an example, the SIMD unit 138 has a bit width of 256 bits and the normal-precision work-items 506 require 32 bits each, while the reduced-precision work-items 504 require 16 bits each. In this example, in a given unit of time, the SIMD unit 138 can execute 8 normal-precision work-items 506 and 16 reduced-precision work-items. Thus, reducing the precision of any particular execution instance 402 increases the speed with which the execution instance 402 will complete. By increasing this speed for execution instances 402 that are considered to have a high workload (as described elsewhere herein), the workload manager 404 reduces the total time required for a given amount of work.

As described elsewhere herein, the execution instances 402 can be any of a variety of entities, such as parallel software entities or parallel hardware entities. Some such examples are now described in greater detail. In one example, the execution instances 402 are workgroups and the workload manager 404 varies the precision of calculations performed by different workgroups. Workgroups operated with a reduced precision complete in less time than if such workgroups operated with a normal precision. In another example, execution instances 402 are wavefronts and the workload manager 404 reduces the precision for some wavefronts, which complete more quickly than if the precision were not reduced. In another example, the execution instances 402 are compute units 132 and the workload manager 404 reduces the precision for one or more compute units 132. All work (e.g., work-items, wavefronts, workgroups, etc.) completed on the reduced-precision compute units 132 are completed with this reduced precision and complete more quickly than if not reduced. In yet another example, the execution instances 402 are SIMD units 138 and all work (e.g., wavefronts) that execute within the reduced-precision SIMD units 138 complete more quickly than if executed at normal precision.

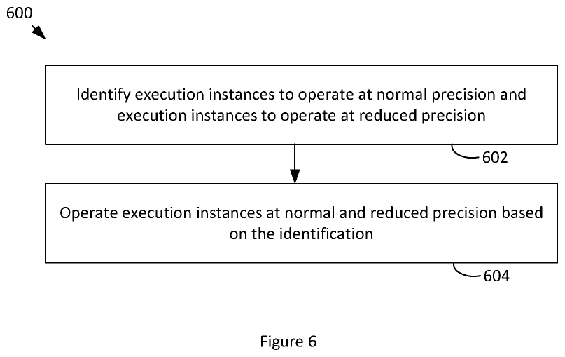

FIG. 6 is a flow diagram of a method 600 for operating a device with reduced or normal precision, in accordance with an example. Although described with respect to the system of FIG. 1-5, those of skill in the art will understand that any system configured to perform the steps of the method 600 in any technically feasible order falls within the scope of the present disclosure.

At step 602, the workload manager 404 identifies the execution instances 402 that are to operate at normal precision and the execution instances 402 that are to operate at the reduced precision. As described elsewhere herein, execution instances 402 that meet a workload criterion are determined to operate at the reduced precision and execution instances that do not meet the workload criterion are determined to operate at the normal precision. In some examples, the workload criterion is whether the workload measure of the execution instance 402 is above a workload threshold. The workload measure is any technically feasible quantity that indicates how busy the execution instance 402 is. In some examples, the threshold is set based on an analysis of all execution instances 402 in a set. More specifically, in some examples, the threshold is set such that a significant outlier, if any, is considered to be above the threshold. In such instances, it is possible that no execution instances 402 have a workload measure above the threshold, if all workload measures are close together. In an example, the threshold is one standard deviation from the mean of the workload measure, or is some multiplier of the standard deviation from the mean. Any other technically feasible manner to limit the threshold such that only “outliers” are above that threshold could be used. In some examples, the group considered together in order to identify “outliers” is any technically feasible group such as all execution instances 402 executing within a particular hardware item (e.g., all workgroups in a compute units 132), or all hardware units within a parent hardware unit (e.g., all SIMD units 138 in the compute unit 132 or all compute units 132).

At step 604, the workload manager 404 operates the execution instances in accordance with the identification. More specifically, the workload manager 404 operates the execution instances 402 determined to execute with reduced precision with such precision and operates executes the execution instances 402 determined to execute with normal precision with such precision. In the example described elsewhere herein, reducing the precision allows a greater number of work-items to execute in parallel, which reduces the overall execution time as compared with a situation in which the execution instances 402 were executed with normal precision.

It should be understood that many variations are possible based on the disclosure herein. In an example, although two different levels precision are described, it is possible to use multiple workload measure thresholds to cause execution instances 402 to execute at more than two different levels of precision. In such an example, multiple thresholds would be used to select a particular level. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, output merger stage 318, workload manager 404, and execution instances 402 are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing computing work, the method comprising:
identifying a first set of execution instances to operate at a normal precision and a second set of execution instances to operate at a reduced precision, wherein both the first set of execution instances and the second set of execution instances specify operation at the normal precision; and
operating the first set of execution instances at the normal precision and the second set of execution instances at the reduced precision.

2. The method of claim 1, wherein identifying the second set of execution instances includes identifying one or more execution instances, of a set of execution instances, that have a workload measure greater than a threshold.

3. The method of claim 1, wherein identifying the first set of execution instances includes identifying one or more execution instances, of a set of execution instances, that have a workload measure that is not greater than a threshold.

4. The method of claim 2, wherein the workload measure indicates how busy an execution instance is.

5. The method of claim 2, wherein the threshold is based on workload measures of the first set of execution instances and the second set of execution instances.

6. The method of claim 5, wherein the threshold is a number of standard deviations above a mean of the workload measures of the first set of execution instances and the second set of execution instances.

7. The method of claim 2, wherein the threshold is an absolute value.

8. The method of claim 1, wherein execution instances operated at the reduced precision are operated with work-items that utilize fewer bits than execution items operated at the normal precision.

9. The method of claim 2, wherein the workload measure is based on performance counters.

10. A system for performing computing work, the system comprising:
a processor configured to:
identify a first set of execution instances to operate at a normal precision and a second set of execution instances to operate at a reduced precision, wherein both the first set of execution instances and the second set of execution instances specify operation at the normal precision; and
operating the first set of execution instances at the normal precision and the second set of execution instances at the reduced precision; and
one or more memories storing information for the first set of execution instances and the second set of execution instances.

11. The system of claim 10, wherein identifying the second set of execution instances includes identifying one or more execution instances, of a set of execution instances, that have a workload measure greater than a threshold.

12. The system of claim 10, wherein identifying the first set of execution instances includes identifying one or more execution instances, of a set of execution instances, that have a workload measure that is not greater than a threshold.

13. The system of claim 11, wherein the workload measure indicates how busy an execution instance is.

14. The system of claim 11, wherein the threshold is based on workload measures of the first set of execution instances and the second set of execution instances.

15. The system of claim 14, wherein the threshold is a number of standard deviations above a mean of the workload measures of the first set of execution instances and the second set of execution instances.

16. The system of claim 11, wherein the threshold is an absolute value.

17. The system of claim 10, wherein execution instances operated at the reduced precision are operated with work-items that utilize fewer bits than execution items operated at the normal precision.

18. The system of claim 11, wherein the workload measure is based on performance counters.

19. A non-transitory computer-readable medium storing instructions that, when executed by a processor, cause the processor to perform operations comprising:
identifying a first set of execution instances to operate at a normal precision and a second set of execution instances to operate at a reduced precision, wherein both the first set of execution instances and the second set of execution instances specify operation at the normal precision; and
operating the first set of execution instances at the normal precision and the second set of execution instances at the reduced precision.

20. The non-transitory computer-readable medium of claim 19, wherein identifying the second set of execution instances includes identifying one or more execution instances, of a set of execution instances, that have a workload measure greater than a threshold.
